(19) United States
(12) Patent Application Publication
(10) Pub. No.: US 2005/0087209 A1
(43) Pub. Date: Apr. 28, 2005

(54) Megasonic processing system with gasified fluid

(76) Inventors: Thomas J. Nicolosi JR., Mission Viejo, CA (US); Yi Wu, Irvine, CA (US); Ismail Kaskkoush, Orefield, PA (US)

Correspondence Address: COZEN O'CONNOR, P.C., 1900 MARKET STREET, PHILADELPHIA, PA, 19103-3508, US

(21) Appl. No.: 10/931,457

(22) Filed: Sep. 1, 2004

Related U.S. Application Data
(63) Continuation-in-part of application No. 10/742,214, filed on Dec. 19, 2003.
Application No. 10/742,214 is a continuation of application No. 09/906,384, filed on Jul. 16, 2001, now Pat. No. 6,684,890.

(51) Int. Cl. B08B 3/12

(52) U.S. Cl. 134/1; 134/1.3; 134/100.1; 134/148; 134/184; 134/902

(57) ABSTRACT

An apparatus and method for substrate processing, specifically including cleaning and/or photoresist stripping, in non-immersion type megasonic processing tools. In one embodiment, the invention utilizes the concept of dissolving a gas into a liquid at or near the point of use with a gasifier, such as a membrane contactor, during the processing of the substrate, thus eliminating the need for pre-made liquid/gas processing mixtures that are typically stored in auxiliary tanks. In one aspect, the invention is an apparatus comprising: a process chamber having a support for supporting a substrate; a source of liquid; a supply line coupling said source of liquid to said process chamber; a gasifier operatively coupled to said supply line, said gasifier causing a gas to be dissolved into said liquid to form a mixture of said liquid and said gas; means for applying a film of said mixture to one side of said substrate while on said support, said first means being in fluid association with said supply line; and a transmitter configured to apply sonic energy to said substrate. The method comprises, in one aspect: supporting a substrate in a process chamber; supplying a liquid to said process chamber from a source of said liquid via a supply line; dissolving a gas into said liquid with a gasifer operatively coupled to said supply line to form a mixture of said liquid and said gas; applying a film of said mixture to one side of said substrate; and applying sonic energy to said substrate while said mixture is being applied. When used to remove photoresist from substrates, the fluid will preferably be deionized water and the gas will be ozone gas.

### CROSS REFERENCE TO RELATED APPLICATIONS

This application is a continuation-in-part application of U.S. patent application Ser. No. 10/742,214, filed Dec. 19, 2003, which is a continuation application of U.S. application Ser. No. 09/906,384, filed on Jul. 16, 2001, now issued as U.S. Pat. No. 6,684,890.

### FIELD OF THE INVENTION

The present invention relates generally to apparatus and methods for processing substrates, and specifically to apparatus and methods of cleaning and/or removing photoresist from semiconductor wafers. However, the invention can also be applied to the manufacture of raw wafers, lead frames, medical devices, disks and heads, flat panel displays, microelectronic masks, and other applications requiring high purity fluids for processing.

### BACKGROUND OF THE INVENTION

Megasonic cleaning systems are widely used within the semiconductor industry for cleaning and/or stripping photoresist from substrates such as semiconductor wafers, photomasks, flat-panel displays, magnetic heads or any other similar item that requires a high level of cleanliness. In a megasonic cleaner, the substrates are immersed in or otherwise exposed to a cleaning solution, typically water containing a dilute amount of cleaning chemicals. A source of megasonic energy is activated to agitate the solution and create a cleaning (or photoresist removal) action at the exposed surfaces of the substrates.

In preparing processing solutions for megasonic cleaners, gasified water has to date been used only when performing batch cleaning of substrates, such as in an open bath-type megasonic cleaners wherein the substrates are immersed in the cleaning solution. For example, U.S. Pat. No. 5,800,626 teaches the use of gasified cleaning solutions in connection with a bath-type megasonic cleaning systems. However, gasified cleaning solutions have not been shown to be effective in use with non-immersion type megasonic cleaners, such as probe-type megasonic cleaners for example. Typically, in a non-immersion type megasonic cleaner, a single substrate is supported in a chamber while a thin film of cleaning (or other process) fluid is applied to the substrate as it rotates. A source of megasonic energy is coupled to the film and transmits megasonic energy to the substrate through the thin layer of fluid.

With the recent introduction of non-immersion megasonic cleaners it has been widely believed unnecessary to gasify the water supplied to the cleaning device, and has even been believed necessary to de-gas the water. Various reasons underlied these beliefs. First, in non-immersion type cleaners, the megasonic energy source is much closer to the substrate being cleaned. This was thought to obviate the need for any additional cleaning (or stripping) action contributed by the presence or addition of gases dissolved in the solution. In addition, many in the industry believed that the spraying, under pressure, of solution onto the substrate which typically occurs in non-immersion type systems would aerate the water somewhat and provide the (then presumably modest, if at all) amount of dissolved gas needed for satisfactory cleaning performance with non-immersion type cleaners. In other words, it was presumed that the non-immersion type systems would behave in a similar manner as open-tank batch megasonic baths, in which the solution includes gases dissolved from the ambient air.

Finally, there has been a fear that excessive oxygen dissolved in the water may react with the hydrogen terminated silicon surface of a substrate and cause, under the high levels of agitation created by non-immersion type cleaning systems, an unacceptable amount of roughening. As a result, the accepted guideline for non-immersion type megasonic cleaning processes has been that the water supply contain less than 1 ppb of oxygen in solution.

In light of these widely held beliefs, the inventors were surprised to discover that the gasification of the process liquids used in non-immersion type megasonic cleaning systems led to substantially improved cleaning performance. In addition to cleaning, the inventors have also been surprised that the inventive gasification techniques can also be used to perform a variety of other processes, such as to remove photoresist from substrates.

Moreover, to the extent that the use of gasified process liquids have been used in non-immersion type megasonic cleaners, these gasified process liquids are pre-made and stored in holding tanks/drums. When needed for processing, the holding tank is coupled to the process fluid supply system and the gasified process liquid is drawn from the holding tank and supplied to the substrate surface. The use of pre-made gasified liquids is undesirable because the gas trapped in the liquid may pick of particles/contaminants from the holding tank and/or the supply lines and carry these particles/contaminants to the surface of the substrates being processed, thereby resulting in device failure and/or inadequate processing.

### SUMMARY OF THE INVENTION

In accordance with one embodiment there is provided a method of improving the performance of a substrate processing tool of the non-immersion type having megasonic application capabilities. The inventive method and apparatus can be used to perform a variety of substrate processing steps, specifically including cleaning and/or photoresist stripping

In one aspect, the invention is an apparatus for processing substrates comprising: a process chamber having a support for supporting a substrate; a source of liquid; a supply line coupling said source of liquid to said process chamber; a gasifier operatively coupled to said supply line, said gasifier causing a gas to be dissolved into said liquid to form a mixture of said liquid and said gas; means for applying a film of said mixture to one side of said substrate while on said support, said first means being in fluid association with said supply line; and a transmitter configured to apply sonic energy to said substrate.

By providing the gasifier on the supply line, gases, such as O3, NH₃, N₂, CO₂, H₂, HCl, HF, can be dissolved into the liquid to form the gas/liquid mixture as the liquid travels to the process chamber, thereby eliminating the need of an auxiliary tank of pre-made liquid/gas mixtures. Positioning the gasifier at or near the point of use also reduces the possibility of contaminants being carried to the substrate surface because the liquid/gas mixture does not have to travel very far before contacting the substrate. Preferably, the liquid is a degassed liquid, such as deionized water, and the gasifier is positioned on the supply line within a range of 1 to 50 inches of the process chamber. This helps to further reduce the amount of contaminants carried to the substrate surface. However, it is not necessary to de-gas the liquid.

Preferably, the support is adapted to support the substrate in a substantially horizontal orientation during processing. However, the invention is not so limited and the substrate can be supported in a vertical or angled orientation during processing.

It is further preferable that the apparatus also comprise a means for applying a film of fluid to an opposite side of the substrate while the substrate is on the support. This film of fluid can be a single liquid, a liquid-liquid mixture, or a gas-liquid mixture. Adapting the apparatus to have the ability to apply films of processing fluids to both sides of the substrate at once allows both sides of the substrate to be processed simultaneously if desired. The transmitter is preferably coupled to (i.e. in contact with) one of the films, thereby applying sonic energy to the substrate through one of said films. Most preferably, the transmitter is configured to apply sonic energy with sufficient power so that the sonic energy passes through the film to which it is coupled, through the substrate itself, and into the film on the opposite side of the substrate, thereby simultaneously subjecting both sides of the substrate to the sonic energy. It is also preferred that the transmitter have a portion that is substantially parallel to one of the sides of the substrate when applying sonic energy to said substrate. One such embodiment can be an elongated probe. Other embodiments can be plate-like or pie-shaped transmitters being generally parallel to one of the substrate surfaces. Another type of suitable source of sonic energy can comprise a transmitter that is not directly coupled to one of the films but rather reflects the sonic energy off various surfaces before the sonic energy reaches the film.

The means for applying the film of the mixture (and/or the film of the fluid) is preferably a nozzle (supplied with the pressurized gasified liquid), but can take on a variety of other embodiments, including sprayers, conduits, passageways, or other dispensers. The gasifier can be a membrane contactor. When the apparatus is adapted to perform photoresist stripping, the gas will preferably be ozone and the liquid will be deionized water. In this embodiment, the ozone gas can be supplied to the gasifier from an ozone generator.

The substrate support preferably comprises a rotary fixture configured to rotate the substrate during application of the film of the mixture (and/or fluid) and the sonic energy. In another aspect, the invention is a method for processing substrates comprising: supporting a substrate in a process chamber; supplying a liquid to said process chamber from a source of said liquid via a supply line; dissolving a gas into said liquid with a gasifer operatively coupled to said supply line to form a mixture of said liquid and said gas; applying a film of said mixture to one side of said substrate; and applying sonic energy to said substrate while said mixture is being applied. The gas is preferably dissolved into the liquid as the substrate is being processed.

The substrate is preferably supported in a substantially horizontal orientation during the processing. Additionally, a film of fluid can be applied to an opposite side of the substrate. This film of fluid can be a single liquid, a liquid-liquid mixture, or a gas-liquid mixture. This allows both sides of the substrate to processed simultaneously if desired. In this embodiment, the sonic energy will preferably be applied to the side of the substrate on which the film of the mixture is applied via a transmitter that is coupled to the film of the mixture. However, the transmitter can be coupled to the film of fluid on the opposite side of the substrate. In this arrangement, the transmitter preferably provides the sonic energy with sufficient power so that the sonic energy passes through the coupled film of fluid, through the substrate itself, and into the film of the mixture. This will simultaneously subject both sides of the substrate to the sonic energy.

The substrate is preferably rotated during the application of the film of liquid and dissolved gas. It is also preferred that the liquid be a degassed liquid.

When the process being performed is photoresist stripping, the side of the substrate subjected to the film of the mixture will have at least one layer of photoresist thereon. In this embodiment, the liquid is preferably deionized water and the gas is ozone. In other words, the mixture is ozonated deionized water (DIO₃). Most preferably, the amount of ozone dissolved in the deionized water is in the range of 5 to 300 parts per million deionizd water. The process time will vary depending on the concentration. The higher the concentration the shorter the process time.

The application of the film of the DIO₃ mixture deionized, and the application of the sonic energy, will be continued for a time sufficient to remove substantially all photoresist from the one side of said substrate. The sonic energy can be applied to the side of the substrate having the photoresist either by a transmitter positioned on that same side of the substrate as the photoresist or by a transmitter positioned on the opposite side of the substrate. In the case where the transmitter is on the side opposite the photoresist side of the substrate, a film of fluid will preferably be applied to this opposing side. In this arrangement, the transmitter will preferably produce sonic energy with sufficient power so that the sonic energy passes through this fluid film, through the substrate itself, and into the film of DIO₃, thereby simultaneously subjecting both sides of the substrate to said sonic energy.

Finally, it is possible for the method to incorporate one or all of the aspects discussed above with respect to the apparatus of the invention. However, discussion of this will be omitted to avoid redundancy.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

Having thus summarized the general nature of the invention and its essential features and advantages, certain preferred embodiments and modifications thereof will become apparent to those skilled in the art from the detailed description herein having reference to the figures that follow, of which:

FIG. 1 is a schematic view of a known non-immersion probe-type megasonic cleaning system and an associated liquid supply system.

FIG. 2 is a schematic view of the inventive megasonic apparatus according to an embodiment of the present invention.

### DETAILED DESCRIPTION OF THE DRAWINGS

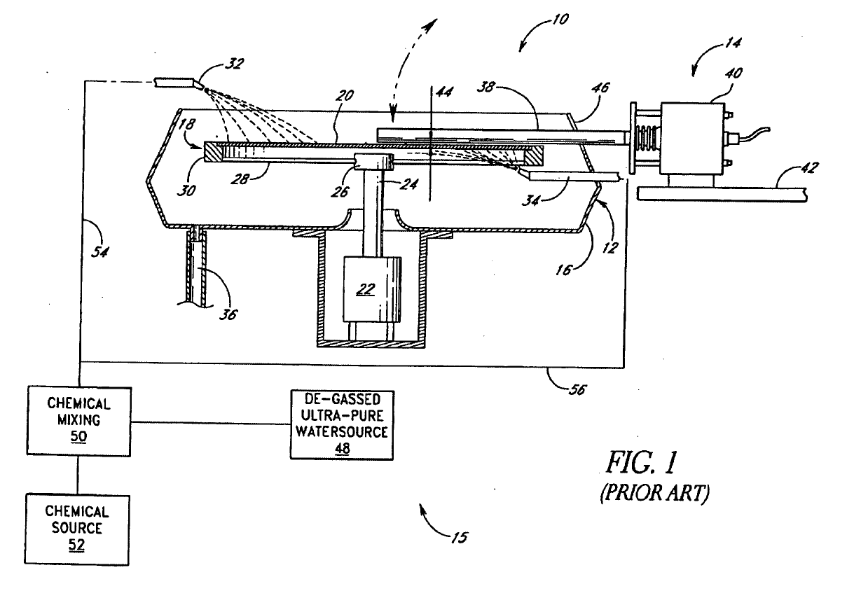

FIG. 1 depicts a known probe-type megasonic cleaning apparatus 10, generally comprising a tank-and-fixture assembly 12, a probe assembly 14 and a cleaning liquid supply system 15. The tank-and-fixture assembly 12 is made up of a tank 16 inside of which is disposed a fixture 18 adapted to support and/or securely hold a substrate 20, which may comprise a semiconductor wafer, photomask, flat-panel display, magnetic heads or any other similar item that requires a high level of cleanliness. The fixture 18 generally comprises a motor 22, shaft 24, hub 26, spokes 28, and an annular rim 30. The rim 30 supports and/or grips the substrate 20 as it is rotated about a generally vertical axis by the motor 22, in cooperation with the shaft, hub, spokes, etc. Upper and/or lower dispensers or nozzles 32, 34 spray a cleaning liquid onto the upper and/or lower surfaces of the substrate 20. A drain line 36 in the lower end of the tank 16 permits accumulated cleaning solution to exit therefrom.

The probe assembly 14 comprises a megasonic probe 38 which is acoustically coupled to a megasonic transducer (not shown) inside of a probe housing 40. The housing 40 is mounted to a support member 42 so that the shaft of the probe 38 extends generally parallel to the surface of the substrate 20 and is separated therefrom by a narrow gap 44. The support member 42, along with the probe assembly 14, is retractable or rotatable upward to allow insertion/removal of substrates to the fixture 18. A slot 46 is provided in the tank 16 to permit rotational movement of the probe 38 in and out of the tank.

In operation, high-frequency electrical power is supplied to the megasonic transducer, which vibrates at a high, megasonic frequency. This vibration is transmitted to the probe 38, which also vibrates at a megasonic frequency. The megasonic vibration of the probe 38 agitates the liquid on the substrate near the probe, creating a cleaning action on the surface of the substrate. Where the lower nozzle 34 is employed to provide cleaning liquid on the lower surface of the substrate 20, this lower-surface liquid is also agitated in the areas nearest the probe. As the substrate rotates under the probe, substantially the entire surface of the substrate is exposed to the cleaning action generated by the probe and agitated liquid.

The cleaning liquid supply system 15 includes a source 48 of de-gassed and ultra-pure water which feeds a chemical mixer 50, in which cleaning chemicals, such as ammonium hydroxide and/or hydrogen peroxide, are added to the ultra-pure water. The cleaning chemicals are drawn from a suitable chemical source 52. Commonly, these chemicals are added at or near the point of use in such proportions as to create a cleaning solution that is ultra-dilute, i.e. having a dilution of 300:1 or more. Such an ultra-dilute solution reduces costs and minimizes unwanted reactions with the substrate surface, such as roughening or etching. Finally, one or more cleaning liquid supply lines 54, 56 carry the mixed cleaning liquid from the mixer 50 to the corresponding nozzle(s) 32, 34 which spray the liquid onto the rotating substrate 20.

Additional details pertaining to megasonic cleaning systems and not necessary to recite here may be found in Assignee's U.S. Pat. No. 6,140,744, issued Oct. 31, 2000 and entitled WAFER CLEANING SYSTEM, the entirety of which is hereby incorporated by reference.

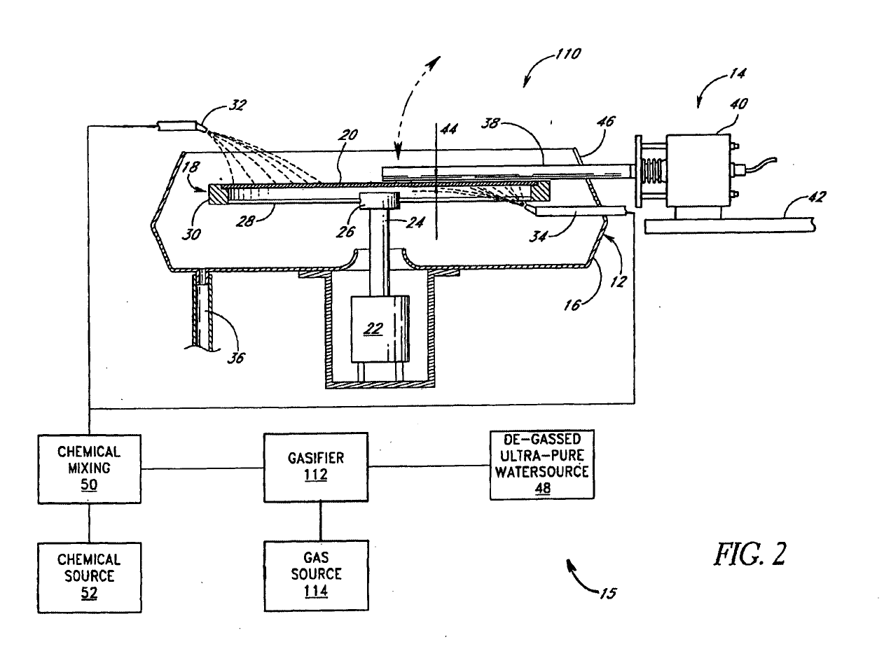

FIG. 2 illustrates a preferred embodiment of the inventive megasonic apparatus 110. The apparatus 110 may be generally similar to the prior-art apparatus 10 disclosed above and depicted in FIG. 1, incorporating the probe assembly 14, tank 16, fixture 18, etc. However, the present invention is by no means limited to application in the specific apparatus 10 disclosed above. One of skill in the art will appreciate that the present invention encompasses use in connection with virtually any megasonic processing apparatus which generates a standing megasonic wave to a surface of a substrate. Examples of prior-art megasonic apparatus are disclosed in U.S. Pat. No. 6,140,744, incorporated by reference above.

The apparatus 110 incorporates a gasifier 112 and gas source 114 which are operatively connected to the process liquid supply system 15 so as to inject or dissolve gas into the liquid. Contrary to the accepted practice for use of probe-type megasonic apparatus, it has been found that the addition of gas to the process liquid provides substantial improvement in performance, such as cleaning and/or photoresist stripping.

The gasifier 112 may comprise any conventional gas injection or mixing device, such as a membrane contactor. Alternatively, the gasifier may comprise any chamber or reservoir which facilitates exposure of the cleaning liquid to the desired gas for a sufficient time to allow the gas to dissolve in the liquid. In one embodiment, the liquid is exposed to the gas until equilibrium is reached for the operating pressure and temperature of the gasifier. In another embodiment, the gasifier exposes the liquid to air or other gas(es) at ambient conditions, i.e. room temperature and pressure. In yet another embodiment, the gasifier comprises an injector which delivers gas under a suitable pressure, for example about 30 PSIG, so as to super-charge the water with gas.

The gasifier 112 may add any suitable reactive or nonreactive gas or gases to the cleaning liquid. For example, the gas may comprise air, nitrogen, ozone, ammonia (NH₃), carbon dioxide (CO₂), hydrogen (H₂), hydrogen chloride (HCl), hydrogen fluoride (HF). If apparatus 110 is to be used to strip photoresist from a substrate, the liquid will be deionized water and the gas will be ozone. Other gases can be injected into the deionized water for point of use chemical generation (POUCG) needed for wafer surface cleaning.

Although one skilled in the art can appreciate that the gasifier 112 can be connected to the cleaning liquid supply system 15 at varying locations, where a pressurized gas injector is used it may advantageously be connected as close as possible to the nozzles 32, 34 (and in one embodiment downstream of the chemical mixer 50) so as to maintain a high level of dissolved gas in the water when it leaves the nozzles.

The inventive apparatus 110 can be used to perform a variety of substrate processing functions, specifically including but not limited to cleaning and photoresist stripping. When the inventive apparatus 110 is used perform a photoresist stripping function, the liquid source 48 will be a deionized water reservoir and the gas source 114 will be an ozone generator. When supply system 115 is activated, deionized water will be drawn from reservoir 48 and flowed into the gasifier 112 via the liquid supply line 60. The gasifier 112 is operatively coupled to the liquid supply line 60. Ozone generator 114 produces ozone gas and supplies this ozone gas to the gasifier 112. The gasifier 112 dissolves the ozone gas into the deionized water passing through to form a mixture of deionized water and ozone gas, i.e., DIO₃.

Once created, the DIO₃ is the transported via supply line 60 to nozzle 32 for application to the top surface of substrate 20 which has at least one layer of photoresist thereon as a film. As the substrate 20 is rotated, the DIO₃ is applied to its surface while megasonic energy is also applied to the substrate via probe transmitter 38. Probe transmitter 38 is contact with (i.e., coupled to) the film of DIO₃. As such, the combined effect of the DIO3 and the applied megasonic energy will remove the photoresist from the substrate 38 surface. The application of the DIO₃ and the megasonic energy is performed for a sufficient time so that substantially all of the photoresist is removed.

Alternatively, the photoresist can be on the bottom surface f the substrate 20. In this case, the DIO₃ will be applied to the bottom surface of the substrate via nozzle 34. In this embodiment, another film of fluid will be applied to the top surface of the substrate 20 and the transmitter probe 38 will supply megasonic energy with sufficient power to pass through the fluid film on the top surface, through the substrate 20, and into the film of DIO₃ on the bottom surface to remove photoresist thereon. It should be noted that the invention is not limited to the transmitter being positioned above the substrate 20. Irrespective of transmitter-type, it is possible for the transmitter to be positioned below the substrate 20 also. Moreover, the substrate 20 can be supported by the support 18 with photoresist side either up or down. The transmitter can be positioned on the photoresist side of the substrate 20 or on the opposite side of the substrate 20. When positioned on the opposite side of the substrate 20, the transmitter should transmit megasonic energy with sufficient power so that the megasonic energy passes through the substrate 20 itself, thereby subjecting both sides of the substrate 20 megasonic vibrations. Finally, it is possible to apply a film of DIO₃ to both sides of a substrate and remove photoresist from both sides of the substrate simultaneously.

As mentioned above, the inventive method and apparatus are not limited to being used to strip photoresist but can be used in performing a variety of substrate processing steps, including cleaning, drying, chemical treatment, etc. An example of a cleaning process is described below.

### CLEANING EXAMPLE

In the following example, a cleaning process is described wherein ultra-pure water is employed as the cleaning solution for a semiconductor wafer and none of the commonly-used cleaning chemicals (such as ammonia or hydrogen peroxide) are added. The ultra-pure water source was de-gassed. Two methods were used to dissolve air into the ultra-pure water: 1) the ultra-pure water was poured into a beaker and left open to the atmosphere; and 2) compressed air was injected into an ultra-pure water supply line in an empty filter housing. All processing was done at room temperature. The contaminant used was a silica polishing slurry that was deposited on the wafer with a sponge and then allowed to dry. The contamination was measured by a commercial laser scattering instrument (KLA-Tencor model SPI). Table 1 shows particle counts measured upon contamination and after cleaning with the megasonic device. In the cases where the solution was gasified, cleaning efficiency was significantly improved.

TABLE 1
Effect of Adding Dissolved Air on
Megasonic Cleaning of Silica Based Slurry

| | | Particle Count | | | | |
|---|---|---|---|---|---|---|
| | | (>0.2 micron size) | | | | |
| Gasified? | Aeration | | Post | Post | | Fraction |
| (Yes/No) | Method | Initial | Contam. | clean | Change | Removed |
| No | None | 177 | 2248 | 2001 | −247 | 0.12 |
| No | None | 1022 | 3317 | 3059 | −258 | 0.11 |
| No | None | 118 | 2281 | 1697 | −584 | 0.27 |
| No | None | 177 | 2001 | 1910 | −91 | 0.05 |
| No | None | 86 | 2310 | 1878 | −432 | 0.19 |
| No | None | 129 | 6642 | 5703 | −939 | 0.14 |
| No | None | 164 | 9287 | 7929 | −1358 | 0.15 |
| Yes | compressed- | 89 | 7181 | 2657 | −4524 | 0.64 |
| | air injection | | | | | |
| Yes | compressed- | 119 | 7621 | 3347 | −4274 | 0.57 |
| | air injection | | | | | |
| Yes | exposure to | 138 | 2659 | 1473 | −1186 | 0.47 |
| | ambient | | | | | |
| Yes | exposure to | 159 | 2619 | 1342 | −1277 | 0.52 |
| | ambient | | | | | |
| Yes | exposure to | 151 | 2133 | 1565 | −568 | 0.29 |
| | ambient | | | | | |
| Yes | exposure to | 712 | 3279 | 1387 | −1892 | 0.74 |
| | ambient | | | | | |
| Yes | exposure to | 82 | 1769 | 997 | −772 | 0.46 |
| | ambient | | | | | |

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above, but should be determined only by a fair reading of the claims that follow.

1. An apparatus for processing substrates comprising:
a process chamber having a support for supporting a substrate;
a source of liquid;
a supply line coupling said source of liquid to said process chamber;
a gasifier operatively coupled to said supply line, said gasifier causing a gas to be dissolved into said liquid to form a mixture of said liquid and said gas;
means for applying a film of said mixture to one side of said substrate while on said support, said first means being in fluid association with said supply line; and
a transmitter configured to apply sonic energy to said substrate.

2. The apparatus of claim 1 wherein said support supports said substrate in a substantially horizontal orientation.

3. The apparatus of claim 1 wherein said means for applying said film of said mixture to said one side of said substrate is a nozzle.

4. The apparatus of claim 1 further comprising a means for applying a film comprising liquid to an opposite side of said substrate while on said support.

5. The apparatus of claim 4 wherein said transmitter is in contact with and applies sonic energy to said substrate through one of said films.

6. The apparatus of claim 4 wherein said transmitter is configured to apply said sonic energy to said substrate with sufficient power so that said sonic energy passes through said substrate, thereby simultaneously subjecting both sides of said substrate to said sonic energy.

7. The apparatus of claim 1 further comprising a source of ozone gas in fluid connection with said gasifer, said gas comprising ozone gas.

8. The apparatus of claim 7 wherein said source of ozone is an ozone generator.

9. The apparatus of claim 1 wherein said liquid is a degassed liquid.

10. The apparatus of claim 9 wherein said liquid is deionized water.

11. The apparatus of claim 1 wherein said liquid comprises deionized water and said gas comprises ozone.

12. The apparatus of claim 1 wherein said transmitter comprises a portion that is substantially parallel to one of said sides of said substrate when applying sonic energy to said substrate.

13. The apparatus of claim 12 wherein said portion comprises an elongated probe.

14. The apparatus of claim 1 wherein said support comprises a rotary fixture configured to rotate said substrate during application of said mixture and said application of said sonic energy.

15. The apparatus of claim 1 wherein said gasifier is located on said supply line within 50 inches of said process chamber.

16. A method for processing substrates comprising:
supporting a substrate in a process chamber;
supplying a liquid to said process chamber from a source of said liquid via a supply line;
dissolving a gas into said liquid with a gasifer operatively coupled to said supply line to form a mixture of said liquid and said gas;
applying a film of said mixture to one side of said substrate; and
applying sonic energy to said substrate while said mixture is being applied.

17. The method of claim 16 wherein said gas being dissolved in said liquid as said substrate is being processed.

18. The method of claim 16 wherein said liquid is deionized water and said gas is ozone.

19. The method of claim 18 wherein the amount of ozone dissolved in said deionized water is in the range of 5 to 300 parts per million deionizd water.

20. The method of claim 18 wherein said one side of said substrate comprises at least one layer of photoresist.

21. The method of claim 20 wherein said application of said mixture and said application of said sonic energy is continued for a time sufficient to remove substantially all photoresist from said one side of said substrate.

22. The method of claim 20 wherein said sonic energy is applied to said one side of said substrate through said film of said mixture via a transmitter positioned on said one side of said substrate.

23. The method of claim 20 further comprising applying a film of fluid to an opposite side of said substrate, wherein said sonic energy is transmitted to said one side of said substrate via a transmitter positioned on said opposite side of said substrate and with sufficient power so that said sonic energy passes through said film of fluid and said substrate, thereby simultaneously subjecting both sides of said substrate to said sonic energy.

24. The method of claim 16 wherein said substrate is supported in a substantially horizontal orientation.

25. The method of claim 16 further comprising the step of applying a film of fluid to an opposite side of said substrate.

26. The method of claim 25 said sonic energy is applied to said one side of said substrate via a transmitter that is coupled to one of said films.

27. The method of claim 16 further comprising rotating said substrate during said application of said film of mixture.

28. The method of claim 16 wherein said liquid is a degassed liquid.
